(19) United States
(12) Patent Application Publication
(10) Pub. No.: US 2004/0249107 A1
(43) Pub. Date: Dec. 9, 2004

(54) Intergrated method for the production of polyurethane foams

(76) Inventors: Ulrich Muller, Neustadt (DE); Joaquim Henrique Teles, Otterstadt (DE); Edward Bohres, Ludwigshafen (DE); Stephan Bauer, Ostercappeln (DE); Raimund Ruppel, Dresden (DE)

Correspondence Address: BASF CORPORATION, LEGAL DEPARTMENT, 1609 BIDDLE AVENUE, WYANDOTTE, MI, 48192, US

(21) Appl. No.: 10/488,522

(22) PCT Filed: Sep. 2, 2002
(86) PCT No.: PCT/EP02/09781

(30) Foreign Application Priority Data
Sep. 4, 2001 (DE) 101 43 195.3

(51) Int. Cl. C08G 18/30; C08G 18/48; C08G 18/52; C08G 18/38

(52) U.S. Cl. 528/76

(57) ABSTRACT

The present invention relates to an integrated process for the preparation of a polyurethane, comprising at least the following steps:

(1) epoxidation of propene with at least one hydroperoxide to give propylene oxide;

(2) reaction of the propylene oxide from step (1) or a mixture of the propylene oxide from step (1) and at least one further alkylene oxide to give a polyether alcohol using at least one multimetal cyanide compound as a catalyst;

(3) reaction of a polyether alcohol from step (2) with at least one isocyanate;

and polyurethanes which can be prepared by a novel process and moldings which contain a novel polyurethane.

The present invention relates to an integrated process for the preparation of polyurethanes from isocyanates and polyetherpolyols and/or modified polyetherols which are obtainable using propylene oxide, in particular by using multimetal cyanide compounds as catalyst, the propylene oxide being prepared by epoxidation of propene with at least one hydroperoxide. In addition, the present invention relates to polyurethanes which can be prepared by a novel process and to moldings which contain a polyurethane prepared according to the invention.

Polyurethanes prepared according to the invention are particularly suitable for the preparation of polyurethane foams, polyurethane cast skins and elastomers.

The properties of the polyurethane, such as mechanical properties and odor, depend to a particularly high degree on the isocyanates and polyether alcohols used for the preparation and may depend on the blowing agents used. In particular, the structure of the polyether alcohols has a considerable effect on the properties of the polyurethanes obtained. The properties of the polyether alcohols are influenced by the process for the preparation of the polyether alcohols and in particular by the properties and the process for the preparation of the starting materials.

The reduction of the impurities in the propylene oxide and/or preparation of the polyether alcohols and/or polyurethanes are of wide interest. The automotive and furniture industries are increasingly demanding polyurethanes which are as free as possible of odorous substances and emissions. Thus, for example, the testing specification of DaimlerChrysler PB VWL 709 of Jan. 11, 2001 prescribes a maximum emission value of 100 ppm for volatile substances and of 250 ppm for condensable substances as mandatory for interior vehicle parts.

On the one hand, the impurities in the polyurethanes lead in many cases to compounds having an intense odor. This restricts the use of the polyurethanes or polyurethane foams. On the other hand, the impurities lead to monofunctional secondary compounds, in particular allyl alcohols, which reduce the functionality of the polyols compared with the theoretical initiator functionality and hence result in a significant deterioration in the mechanical properties, in particular, for example, tensile strength, elongation, tear propagation strength, rigidity and abrasion resistance.

Propylene oxide, prepared by the known processes for the preparation, which are described, for example, in Weissermel, Arpe, Industrielle Organische Chemie, VCH-Verlag, Weinheim, 4th Edition, pages 288 to 318, has the disadvantage that it contains substantial impurities. The contamination is in a range from 5 to 100 ppm.

Polyether alcohols can be prepared, for example, by base- or acid-catalyzed polyaddition of alkylene oxides with polyfunctional initiator compounds. Suitable initiator compounds are, for example, water, alcohols, acids or amines or mixtures of two or more thereof. The disadvantage of such preparation processes is in particular that expensive purification steps are required for separating the catalyst residues from the reaction product. In addition, in the case of polyetherpolyols prepared in this manner, the content of monofunctional products and compounds which have an intense odor and are undesirable for the polyurethane preparation increases with increasing chain length.

The reduction of the functionality is disadvantageous in particular for elastomers since the polyether alcohols used are as a rule bifunctional. As a result of the monofunctional impurities in the polyether alcohol, the functionality is less than 2, which results in a significant deterioration in the mechanical properties of the polyurethane, in particular tensile strength and elongation.

The secondary compounds formed by the secondary reactions of the base- or acid-catalyzed conversion are moreover present in some cases as odorous substances in the polyurethane. Examples are aldehydes, in particular propionaldehyde, cycloacetals, allyl alcohols and the reaction products thereof. The automotive and furniture industries are increasingly demanding polyetherols and polyurethanes which have little odor or are odorless.

Multimetal cyanide compounds are known from the prior art as catalysts for polyadditions, in particular for ring-opening polymerizations of alkylene oxides, as described, for example, in EP-A 0 892 002, EP-1 0 862 977 and EP-A 0 755 716. WO 01/16209 describes a process for the preparation of polyether alcohols by a catalyzed addition reaction of ethylene oxide and propylene oxide with H-functional initiator compounds in the presence of a multimetal cyanide compound.

Thus, for example, WO 00/78837 describes the use of polyetherpolyols, prepared by means of multimetal cyanide catalysts from propylene oxide, for the preparation of flexible polyurethane foams. However, the problem here is that even small amounts of impurities in the propylene oxide lead to coating of the multimetal cyanide catalyst and hence reduce the activity of the catalyst. In addition, impurities in the polyetherpolyol which are already present in the propylene oxide can lead to contamination of the polyurethane prepared. In particular, low molecular weight compounds which result in an odor annoyance may be mentioned in this context. Such impurities can be removed from the propylene oxide or the polymeric products prepared therefrom only by expensive purification steps. Aldehydes and ketones may be mentioned in particular as impurities.

It is an object of the present invention to provide a process for the preparation of polyurethanes which, without expensive purification steps for the starting materials and intermediates, gives polyurethanes which have a low content of impurities, in particular of low molecular weight compounds having an intense odor.

We have found that this object is achieved, according to the invention, by an integrated process for the preparation of a polyurethane, comprising at least the following steps:

(1) epoxidation of propene with at least one hydroperoxide to give propylene oxide;

(2) reaction of the propylene oxide from step (1) or a mixture of the propylene oxide from step (1) and at least one further alkylene oxide to give a polyether alcohol, in particular by using multimetal cyanide compounds as catalyst;

(3) reaction of a polyether alcohol from step (2) with at least one isocyanate.

In the context of the present invention, polyether alcohols are understood as meaning in particular polyetherpolyols and modified polyetherols which are obtainable using propylene oxide.

For the purposes of the present invention, hydrogen peroxide has proven to be a particularly suitable hydroperoxide for the epoxidation according to step (1). This can be prepared outside the reaction according to (1) from hydrogen and oxygen or in situ in the reaction according to (1).

In a preferred embodiment, the present invention therefore relates to an integrated process for the preparation of a polyurethane, the hydroperoxide used in step (1) being hydrogen peroxide.

The epoxidation according to step (1) is disclosed in principle, for example, in DE 10055652.3 and further patent applications of the Applicant, for example DE 10032885.7, DE 10032884.9, DE 10015246.5, DE 19936547.4, DE 19926725.1, DE 19847629.9, DE 19835907.1 and DE 19723950.1, the relevant content of which is hereby incorporated in its entirety in the context of the present application. By means of the epoxidation according to step (1), propylene oxide is obtained in high purity. Thus, the propylene oxide contains in particular <1 ppm of C6 compounds.

In the context of the present invention, C6 compounds are understood as meaning, for example, 2-methylpentane, 4-methylpent-1-ene, n-hexane, hexenes, such as 1-hexene, and components having 6 carbon atoms and additionally one or more functional groups from the class consisting of the aldehydes, carboxylic acids, alcohols, ketones and ethers. Other undesired impurities are propane derivatives, in particular chlorinated propane derivatives, acetaldehyde, propionaldehyde, acetone, dioxolanes, allyl alcohol, pentane, methylpentanes, furan, hexane, hexene, methoxypropane and methanol.

The propylene oxide obtained in step (1) may also contain, as further secondary components, up to 100, in particular up to 40, ppm of methanol and up to 10, preferably up to 4, ppm of acetaldehyde.

Compared with other known processes for the preparation of propylene oxide, which are described, for example, in Weissermel, Arpe, Industrielle Organische Chemie, VCH-Verlag, Weinheim, 4th Edition, pages 288 to 318, the novel step (1) gives propylene oxide which has a very low contamination with C6 components and contains no organochlorine impurities.

In a further embodiment, the present invention therefore relates to an integrated process for the preparation of a polyurethane, the propylene oxide obtained in step (1) containing <1 ppm of C6 impurities.

Suitable conditions for the epoxidation of step (1) are described, for example, in DE 100 55 652.3.

In the novel process, the reaction of the propene with a hydroperoxide, in particular hydrogen peroxide, takes place preferably in the presence of a catalyst. Possible catalysts for the conversion of the propylene into propylene oxide are in principle all catalysts, preferably all heterogeneous catalysts, which are suitable for the respective conversion.

Preferably used catalysts are those which comprise a porous oxidic material, e.g. a zeolite. Catalysts which comprise a titanium-, vanadium-, chromium-, niobium-, tin-, germanium- or zirconium-containing zeolite as porous oxidic materials are preferably used.

In particular, zeolites exist which contain no aluminum and in which titanium as Ti(IV) is present instead of some of the Si(IV) in the silicate lattice. The titanium zeolites, in particular those having a crystal structure of the MFI type, and possibilities for their preparation are described, for example, in EP-A 0 311 983 or EP-A 0 405 978.

It is known that titanium zeolites having the MFI structure can be identified from a specific pattern in the determination of their X-ray diffraction patterns and additionally from a lattice vibration band in the infrared region (IR) at about 960 cm⁻¹ and thus differ from alkali metal titanates or crystalline or amorphous TiO₂ phases.

Specific examples are titanium-, vanadium-, chromium-, niobium-, tin-, germanium- and zirconium-containing zeolites having a pentasil zeolite structure, in particular the types assigned by X-ray analysis to the ABW, ACO, AEI, AEL, AEN, AET, AFG, AFI, AFN, AFO, AFR, AFS, AFT, AFX, AFY, AHT, ANA, APC, APD, AST, ATN, ATO, ATS, ATT, ATV, AWO, AWW, BEA, BIK, BOG, BPH, BRE, CAN, CAS, CFI, CGF, CGS, CHA, CHI, CLO, CON, CZP, DAC, DDR, DFO, DFT, DOH, DON, EAB, EDI, EMT, EPI, ERI, ESV, EUO, FAU, FER, GIS, GME, GOO, HEU, IFR, ISV, ITE, JBW, KFI, LAU, LEV, LIO, LOS, LOV, LTA, LTL, LTN, MAZ, MEI, MEL, MEP, MER, MFI, MFS, MON, MOR, MSO, MTF, MTN, MTT, MTW, MWW, NAT, NES, NON, OFF, OSI, PAR, PAU, PHI, RHO, RON, RSN, RTE, RTH, RUT, SAO, SAT, SBE, SBS, SBT, SFF, SGT, SOD, STF, STI, STT, TER, THO, TON, TSC, VET, VFI, VNI, VSV, WEI, WEN, YUG and ZON structures and to mixed structures of two or more of the abovementioned structures. Titanium-containing zeolites having the UTD-1, CIT-1 or CIT-5 structure are furthermore possible for use in the novel process. Examples of further titanium-containing zeolites are those having the ZSM-48 or ZSM-12 structure.

Titanium zeolites having the MFI, MEL or MFI/MEL mixed structure are to be regarded as being particularly preferred for the novel process. Specifically, the titanium-containing zeolite catalysts which are referred to in general as TS-1, TS-2 and TS-3 and titanium zeolites having a lattice structure isomorphous with beta-zeolite may also be mentioned as being preferred.

A heterogeneous catalyst which comprises the titanium-containing silicalite TS-1 is particularly preferably used in the novel process.

In a further embodiment, the present invention therefore relates to an integrated process for the preparation of a polyurethane, the epoxidation according to step (1) being carried out in the presence of a zeolite catalyst, in particular of a titanium-containing zeolite catalyst.

According to the invention, the propylene oxide obtained by the epoxidation according to step (1) is converted in the presence of suitable catalysts into a polyether alcohol. Examples of catalysts are in particular (a) basic catalysts, for example alkali metal and alkaline earth metal hydroxides, in particular sodium hydroxide or potassium hydroxide or alkali metal alcoholates, e.g. sodium methylate, sodium ethylate, potassium ethylate or potassium isopropylate, (b) acidic catalysts, for example Lewis acids, such as antimony pentachloride, boron fluoride etherate and bleaching earths, and heterogeneous catalysts, such as multimetal cyanide catalysts.

After the synthesis, the catalyst is usually removed by neutralization, distillation and filtration. In the case of the multimetal cyanide catalysis, the catalyst is filtered off, its content is reduced by filtration and/or it remains in the polyetherol.

In a very preferred embodiment, the reaction to give polyether alcohols is carried out in the presence of multimetal cyanide catalysts.

In the reaction to give polyether alcohols, the propylene oxide obtained according to step (1) can be used directly in the reaction according to step (2). For the purposes of the present invention, however, it is also possible for the propylene oxide from step (1) first to be treated, for example purified. According to the invention, a suitable purification is, for example, precision distillation. Suitable processes are described, for example, in EP-B 0 557 116.

For the purposes of the present invention, the propylene oxide obtained according to step (1) can be used alone or together with at least one further alkylene oxide. For the purposes of the present invention, in principle all alkylene oxides which are known to a person skilled in the art can be used, in addition to the propylene oxide obtained according to step (1), for the preparation of a polyether alcohol according to step (2). In particular, substituted or unsubstituted alkylene oxides of 2 to 24 carbon atoms, for example alkylene oxides having halogen, hydroxyl, noncyclic ether or ammonium substituents, are used.

For example, the following are suitable according to the invention: ethylene oxide, 1,2-epoxypropane, 1,2-epoxy-2-methylpropane, 1,2-epoxybutane, 2,3-epoxy-butane, 1,2-epoxy-3-methylbutane, 1,2-epoxypentane, 1,2-epoxy-3-methylpentane, 1,2-epoxyhexane, 1,2-epoxyheptane, 1,2-epoxyoctane, 1,2-epoxynonane, 1,2-epoxydecane, 1,2-epoxyundecane, 1,2-epoxydodecane, 1,2-epoxycyclopentane, 1,2-epoxycyclohexane, (2,3-epoxypropyl)benzene, vinyloxirane, 3-phenoxy-1,2-epoxypropane, 2,3-epoxymethyl ether, 2,3-epoxyethyl ether, 2,3-epoxyisopropyl ether, 2,3-epoxy-1-propanol, 3,4-epoxybutyl stearate, 4,5-epoxypentyl acetate, 2,3-epoxypropyl methacrylate, 2,3-epoxypropyl acrylate, glycidyl butyrate, methyl glycidate, ethyl 2,3-epoxybutanoate, 4-(trimethylsilyl)butane 1,2-epoxide, 4-(triethylsilyl)butane 1,2-epoxide, 3-(perfluoromethyl)propene oxide, 3-(perfluoroethyl)propene oxide, 3-(perfluorobutyl)propene oxide, 4-(2,3-epoxypropyl)morpholine, 1-(oxiran-2-ylmethyl)pyrrolidin-2-one and mixtures of two or more thereof.

Particular examples are aliphatic 1,2-alkylene oxides of 2 to 4 carbon atoms, for example ethylene oxide, 1,2-butylene oxide, 2,3-butylene oxide and isobutylene oxide, aliphatic 1,2-alkylene oxides of 5 to 24 carbon atoms, cycloaliphatic alkylene oxides, for example cyclopentene oxide, cyclohexene oxide or 1,5,9-cyclododecatriene monoxide, and araliphatic alkylene oxides, for example styrene oxide.

For the purposes of the present invention, ethylene oxide, 1,2-epoxypropane, 1,2-epoxybutane, 2,3-epoxybutane, styrene oxide, vinyloxirane and any desired mixtures thereof with one another are particularly suitable, especially ethylene oxide, 1,2-epoxypropane and mixtures of ethylene oxide and 1,2-epoxypropane.

If, in addition to the propylene oxide obtained according to step (1), at least one further alkylene oxide is used, it is possible, according to the invention, to use a mixture of the propylene oxide obtained according to step (1) and at least one further alkylene oxide. However, it is also possible for the purposes of the present invention for the propylene oxide obtained according to step (1) and at least one further alkylene oxide to be added in succession.

The polyether alcohols obtained by the reaction according to step (2) may also have, for example, block structures. The structure of the polyether alcohols can be controlled within wide ranges by suitable reaction conditions. Suitable reaction conditions for the reaction according to step (2) are described, for example, in WO 15 99/16775.

The polyether alcohols obtained according to step (2) can, if required, be modified for the reaction according to step (3). Examples of modified polyetherols are in particular graft polyetherpolyols, in particular those which are prepared by polymerization of styrene and acrylonitrile in the presence of polyetherols, polyurea dispersions (PUD polyols) which are prepared by reacting diisocyanates and diamines in the presence of polyetherols, and polyisocyanate polyadduct polyols (PIPA polyols) which are prepared by reacting diisocyanates and amino alcohols in the presence of polyetherols.

The reaction according to step (2) is carried out in the presence of a multimetal cyanide compound as a catalyst. Suitable catalysts are described, for example, in WO 99/16775 and DE 10117273.7. According to the invention, in particular multimetal cyanide compounds of the formula I are used as catalysts for the reaction according to step (2):

M¹ₐ[M²(CN)_{b}(A)_{c}]_{d}.fM¹_{g}Xₙ.h(H₂O).eL.kP tm (1),

where

M¹ is at least one metal ion selected from the group consisting of Zn²⁺, Fe²⁺, Fe³⁺, Co³⁺, Ni²⁺, Mn²⁺, Co²⁺, Sn²⁺, Pb²⁺, Mo⁴⁺, Mo⁶⁺, Al³⁺, V⁴⁺, V⁵⁺, Sr²⁺, W⁴⁺, W⁶⁺, Cr²⁺, Cr³⁺, Cd²⁺, Hg²⁺, Pd²⁺, Pt²⁺, V²⁺, Mg²⁺, Ca²⁺, Ba²⁺, Cu²⁺, La³⁺, Ce³⁺, Ce⁴⁺, Eu⁺, Ti³⁺, Ti⁴⁺, Ag⁺, Rh²⁺, Rh³⁺, Ru²⁺and Ru³⁺,

M² is at least one metal ion selected from the group consisting of Fe²⁺, Fe³⁺, Co²⁺, Co³⁺, Mn²⁺, Mn³⁺,V⁴⁺, V^{5+‘, Cr}²⁺, Cr³⁺, Rh³⁺, Ru ²⁺and Ir³⁺,

A and X, independently of one another, are an anion selected from the group consisting of halide, hydroxide, sulfate, carbonate, cyanide, thiocyanate, isocyanate, cyanate, carboxylate, oxalate, nitrate, nitrosyl, hydrogen sulfate, phosphate, dihydrogen phospate, hydrogen phosphate or hydrogen carbonate,

L is a water-miscible ligand selected from the group consisting of alcohols, aldehydes, ketones, ethers, polyethers, esters, polyesters, polycarbonate, ureas, amides, primary, secondary and tertiary amines, ligands having pyridine nitrogen, nitriles, sulfides, phosphides, phosphites, phosphanes, phosphonates and phosphates,

k is a fraction or integer greater than or equal to zero and

P is an organic additive,

a, b, c, d, g and n are selected so that the electroneutrality of the compound (I) is ensured, it being possible for c to be 0,

e is the number of ligand molecules and is a fraction or integer greater than 0 or is 0, and

f, k, h and m, independently of one another, are a fraction or integer greater than 0 or are 0.

Examples of organic additives P are: polyether, polyester, polycarbonates, polyalkylene glycol sorbitan ester, polyalkylene glycol glycidyl ether, polyacrylamide, poly(acrylamide-co-acrylic acid), polyacrylic acid, poly(acrylamide-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxylethylcellulose, polyacetates, ionic surface-active and interface-active compounds, bile acid or its salts, esters or amides, carboxylates of polyhydric alcohols and glycosides.

These catalysts may be crystalline or amorphous. Where k is zero, crystalline multimetal cyanide compounds are preferred. Where k is greater than zero, crystalline, semicrystalline and substantially amorphous catalysts are preferred.

Among the modified catalysts, there are various preferred embodiments. One preferred embodiment comprises catalysts of the formula (I) in which k is zero. The preferred catalyst then contains at least one multimetal cyanide compound, at least one organic ligand and at least one organic additive P.

In the case of another preferred embodiment, k is zero, e is optionally also zero and X is exclusively a carboxylate, preferably formate, acetate or propionate. Such catalysts are described in WO 99/16775. In the case of this embodiment, crystalline multimetal cyanide catalysts are preferred. Multimetal cyanide catalysts as described in WO 00/74845, which are crystalline and lamellar, are furthermore preferred.

The modified catalysts are prepared by combining a metal salt solution with a cyanometallate solution, which may optionally contain both an organic ligand L and an organic additive P. The organic ligand and optionally the organic additive are then added. In a preferred embodiment of the catalyst preparation, an inactive multimetal cyanide phase is first prepared and this is then converted by recrystallization into an active multimetal cyanide phase, as described in PCT/EP01/01893.

In another preferred embodiment of the catalysts, f, e and k are not equal to zero. These are multimetal cyanide catalysts which contain a water-miscible organic ligand (generally in amounts of from 0.5 to 30% by weight) and an organic additive (generally in amounts of from 5 to 80% by weight) (WO 98/06312). The catalysts can be prepared either by vigorous stirring (24 000 rpm with Turrax) or with stirring (U.S. Pat No. 5,158,922).

Other suitable catalysts are described in WO 01/03830. Such multimetal cyanide catalysts are prepared using organic sulfones of the general form R—S(O)₂—R or sulfoxides of the general form R—S(O)—R as organic complexing agents. Short induction times and moderate exothermic properties may be mentioned as advantages of the catalyst. WO 01/03831 describes a further variant of the catalyst synthesis. There, multimetal cyanide catalysts are synthesized by an incipient wetness method. These catalysts can likewise be used for the novel process.

Further multimetal cyanide catalysts suitable according to the invention comprising metal[hexacyanometallate-hexanitrometallate] are mentioned in WO 01/04182. The starting compounds mentioned there are more economical than the generally used zinc hexacyanocobaltates. Moreover, the catalysts have shorter induction times and in some cases they have moderate exothermic properties. However, the multimetal cyanide catalysts thus prepared may also be supported, as described in WO 01/04180 (polycarboxylic acids) and WO 01/04177 (zeolites). Consequently, the catalyst can be easily removed.

A multimetal cyanide catalyst also suitable according to the invention can be prepared, according to WO 01/04181, on the basis of hexacyanocobaltate-nitroferrocyanide. These catalysts have short induction times in the polymerization of alkylene oxides to polyethers.

Catalysts particularly suitable for the novel process are multimetal cyanide compounds which contain zinc, cobalt or iron or two thereof. For example, Prussian Blue is particularly suitable.

In a preferred embodiment, the present invention therefore relates to an integrated process for the preparation of a polyurethane, the multimetal cyanide compound containing zinc, cobalt or iron or two thereof.

According to the invention, propylene oxide from step (1) or a mixture of the propylene oxide from step (1) and at least one further alkylene oxide is reacted with an initiator compound in step (2).

Examples of initiator molecules are: water, organic dicarboxylic acids, such as succinic acid, adipic acid, phthalic acid and terephthalic acid, aliphatic and aromatic, unsubstituted or N-mono- and N,N- and N,N′-dialkyl-substituted diamines having 1 to 4 carbon atoms in the alkyl radical, such as unsubstituted or mono- and dialkyl-substituted ethylenediamine, diethylenetriamine, triethylenetetramine, 1,3-propylenediamine, 1,3- and 1,4-butylenediamine, 1,2-,1,3-, 1,4-, 1,5- and 1,6-hexamethylenediamine, phenylenediamines, 2,3-, 2,4- and 2,6-toluenediamine and 4,4′-, 2,4′- and 2,2′-diaminodiphenylmethane. Other suitable initiator molecules are: aLkanolamines, e.g. ethanolamine, N-methyl- and N-ethylethanolamine, dialkanolamines, e.g. diethanolamine and N-methyl- and N-ethyldiethanolamine, and trialkanolamines, e.g. triethanolamine and ammonia and polyhydric alcohols, such as monoethylene glycol, 1,2- and 1,3-propanediol, diethylene glycol, dipropylene glycol, 1,4-butanediol, 1,6-hexanediol, glycerol, trimethylolpropane, pentaerythritol, sorbitol and sucrose. Preferably used polyether polyalcohols are adducts of ethylene oxide and/or propylene oxide with water, monoethylene glycol, diethylene glycol, 1,2-propanediol, dipropylene glycol, glycerol, trimethylolpropane, ethylenediamine, triethanolamine, pentaerythritol, sorbitol and/or sucrose, individually or as mixtures.

According to the invention, the initiator substances can also be used in the form of alkoxylates, in particular those having a molecular weight Mw of from 62 to 15,000 g/mol.

However, macromolecules possessing functional groups having active hydrogen atoms, for example hydroxyl groups, in particular those which are mentioned in WO 01/16209, are also suitable.

The polyether alcohols obtained according to step (2) can be reacted with isocyanates according to step (3). Step (3) may follow step (2) directly. However, it is also possible for an additional step, in particular a purification step, to be carried out between step (2) and step (3).

One or more isocyanates can be used for the purposes of the present invention. In addition to the polyether alcohol which is obtained from step (2), further compounds having groups reactive toward isocyanates, in particular having hydroxyl groups, can also be used for the reaction according to step (3).

For example, polyesters, further polyethers, polyacetals, polycarbonates, polyester ethers and the like may be used as further OH components.

Suitable polyesterpolyols can be prepared, for example, from organic dicarboxylic acids of 2 to 12 carbon atoms, preferably aliphatic dicarboxylic acids of 4 to 6 carbon atoms, and polyhydric alcohols, preferably diols, of 2 to 12, preferably 2 to 6, carbon atoms. Examples of suitable dicarboxylic acids are: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used both individually and as a mixture with one another. Instead of the free dicarboxylic acids, the corresponding dicarboxylic acid derivatives, e.g. dicarboxylates of alcohols of 1 to 4 carbon atoms or dicarboxylic anhydrides, may also be used. Examples of dihydric and polyhydric alcohols are: ethanediol, diethylene glycol, 1,2- and 1,3-propanediol, dipropylene glycol, 1,4-butanediol, 1,5-pentanediol, 1,6-hexanediol, 1,10-decanediol, 1,12-dodecanediol, glycerol and/or trimethylolpropane. Ethanediol, diethylene glycol, 1,4-butanediol, 1,5-pentanediol, 1,6-hexanediol, glycerol and/or trimethylolpropane are preferably used. Polyesterpolyols obtained from lactones, e.g. caprolactone, or hydroxycarboxylic acids, e.g. hydroxycaproic acid, may also be used. For the preparation of the polyesterpolyols, the organic, for example aromatic and preferably aliphatic, polycarboxylic acids and/or polycarboxylic acid derivatives and polyhydric alcohols can be subjected to polycondensation in the absence of a catalyst or preferably in the presence of esterification catalysts, expediently in an atmosphere comprising inert gas, e.g. nitrogen, carbon monoxide, helium, argon, etc., in the melt at from 150 to 250° C., preferably from 180 to 220° C., under atmospheric or reduced pressure to the desired acid number, which is advantageously less than 10, preferably less than 2. According to a preferred embodiment, the esterification mixture is subjected to polycondensation at the abovementioned temperatures to an acid number of from 80 to 30, preferably from 40 to 30, under atmospheric pressure and then under a pressure of less than 500, preferably from 50 to 150, mbar. Examples of suitable esterification catalysts are iron, cadmium, cobalt, lead, zinc, antimony, magnesium, titanium and tin catalysts in the form of metals, metal oxides or metal salts. However, the polycondensation can also be carried out in the liquid phase in the presence of diluents and/or entraining agents, e.g. benzene, toluene, xylene or chlorobenzene, for the removal of the condensation water by azeotropic distillation. For the preparation of the polyesterpolyols, the organic polycarboxylic acids and/or polycarboxylic acid derivatives and polyhydric alcohols are advantageously subjected to polycondensation in a molar ratio of from 1:1 to 1:1.8, preferably from 1:1.05 to 1:1.2. The polyesterpolyols obtained preferably have a functionality of from 2 to 4, in particular from 2 to 3, and a hydroxyl number of, preferably, from 20 to 200 mg KOH/g. Furthermore, diols, triols and/or polyols having molecular weights of from 60 to <400 may be used as compounds reactive toward isocyanates, for example aliphatic, cycloaliphatic and/or araliphatic diols of 2 to 14, preferably 4 to 10, carbon atoms, e.g. ethylene glycol, 1,3-propanediol, 1,10-decanediol, o-, m- and p-dihydroxycyclohexane, diethylene glycol, dipropylene glycol and preferably 1,4-butanediol, 1,6-hexanediol and bis(2-hydroxyethyl)hydroquinone, triols, such as 1,2,4- and 1,3,5-trihydroxycyclohexane, glycerol and trimethylolpropane, and low molecular weight hydroxyl-containing polyalkylene oxides based on ethylene oxide and/or 1,2-propylene oxide and the abovementioned diols and/or triols as initiator molecules.

According to the invention, the polyether alcohol from step (2) is reacted with at least one isocyanate. According to the invention, all isocyanates known to a person skilled in the art are in principle suitable. Particular examples are: aromatic, araliphatic, aliphatic and/or cycloaliphatic organic isocyanates, preferably diisocyanates. Specific examples are: alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, lysine ester diisocyanates (LDI) and/or hexamethylene 1,6-diisocyanate (HDI); cycloaliphatic diisocyanate, such as cyclohexane 1,3- and 1,4-diisocyanate and any desired mixtures of these isomers, hexahydrotolylene 2,4- and 2,6-diisocyanate and the corresponding isomer mixtures, dicyclohexylmethane 4,4′-, 2,2′- and 2,4′-diisocyanate and the corresponding isomer mixtures and/or 1-isocyanato-3,3,5-trimethyl-5-isocyanatomethylcyclohexane (IPDI). Further examples of isocyanates are: tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates polyphenylpolymethylene polyisocyanates, mixtures of diphenylmethane 4,4′-,2,4′- and 2,2′-diisocyanates and polyphenylpolymethylene polyisocyanates (crude MDI) and mixtures of crude MDI and tolylene diisocyanates. Mixtures containing at least two of said isocyanates may also be used. Furthermore, modified di- and/or polyisocyanates containing isocyanurate, biuret, ester, urea, allophanate, carbodiimide, uretdione and/or urethane groups, the latter also referred to below as urethane-modified, can be used in the novel process. Specific examples are: organic polyisocyanates containing urethane groups and having NCO contents of from 50 to 10, preferably from 35 to 15, % by weight, based on the total weight, for example diphenylmethane 4,4′-diisocyanate modified with low molecular weight diols, triols, dialkylene glycols, trialkylene glycols or polyalkylene glycols having molecular weights of up to 6000, in particular up to 1500, modified diphenylmethane 4,4′- and 2,4′-diisocyanate mixtures, modified crude MDI or tolylene 2,4- and 2,6-diisocyanate, examples of di- and polyoxyalkylene glycols, which may be used individually or as mixtures, being: diethylene glycol, dipropylene glycol, polyoxyethylene, polyoxypropylene and polyoxypropylene polyoxyethylene glycols and the corresponding triols and/or tetrols. Also suitable are NCO-containing prepolymers having NCO contents of from 25 to 3.5, preferably from 21 to 14, % by weight, based on the total weight, prepared from the described polyesterpolyols and/or preferably polyetherpolyols and diphenylmethane 4,4′-diisocyanate, mixtures of diphenylmethane 2,4′- and 4,4′-diisocyanate, tolylene 2,4- and/or 2,6-diisocyanates or crude MDI. Liquid polyisocyanates containing carbodiimide groups and having NCO contents of from 33.6 to 15, preferably from 31 to 21, % by weight, based on the total weight, for example based on diphenylmethane 4,4′-, 2,4′- and/or 2,2′-diisocyanate and/or tolylene 2,4- and/or 2,6-diisocyanate, have furthermore proven useful. The modified polyisocyanates can, if required, be mixed with one another or with unmodified organic polyisocyanates, e.g. diphenylmethane 2,4′- or 4,4′-diisocyanate, crude MDI or tolylene 2,4- and/or 2,6-diisocyanate. Preferably used modified isocyanates are isocyanurated, biuretized and/or urethane-modified aliphatic and/or cycloaliphatic diisocyanates, for example the abovementioned ones, which may have been biuretized and/or cyanurated by generally known processes and have at least one free isocyanate group, preferably at least two, particularly preferably three, free isocyanate groups. The trimerization of the isocyanates for the preparation of the isocyanates having an isocyanurate structure can be effected at customary temperatures in the presence of known catalysts, for example phosphines and/or phosphine derivatives, amines, alkali metal salts, metal compounds and/or Mannich bases. Trimerized isocyanates containing isocyanurate structures are also commercially available. Isocyanates having biuret structures can be prepared by generally known processes, for example by reacting said diisocyanates with water or, for example, diamines, a urea derivative being formed as an intermediate. Biuretized isocyanates are also commercially available.

The reaction according to step (3) is carried out under the conditions known to a person skilled in the art. Suitable reaction conditions are described, for example, in Becker, Braun, Polyurethane, Kunststoffhandbuch, Volume 7, Carl Hanser Verlag, Munich, 3rd Edition, 1993, pages 139 to 193.

If required, further, low molecular weight compounds may also be present as additives in the reaction according to step (3). Such compounds can act, for example, as chain extenders or stopping reagents. For example, primary amino compounds having from two to about 20, for example from 2 to about 12, carbon atoms are suitable for this purpose. These are, for example, ethylamine, n-propylamine, isopropylamine, sec-propylamine, tert-butylamine, 1-aminoisobutane, substituted amines having from two to about 20 carbon atoms, such as 2-(N,N-dimethylamino)-l-aminoethane, aminomercaptans, such as 1-amino-2-mercaptoethane, diamines, aliphatic amino alcohols having from 2 to about 20, preferably from 2 to about 12, carbon atoms, for example methanolamine, 1-amino-3,3-dimethylpentan-5-ol, 2-aminohexane-2′, 2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, aromatic-aliphatic or aromatic-cycloaliphatic aminoalcohols having from 6 to about 20 carbon atoms, suitable aromatic structures being heterocyclic ring systems or preferably isocyclic ring systems, such as naphthalene derivatives or in particular benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3propanediol, and mixtures of two or more of such compounds.

The reaction according to step (3) can be carried out in the presence or absence of a catalyst. Suitable catalysts are in principle all compounds which greatly accelerate the reaction of isocyanates with the compounds reactive toward isocyanates, the preferably used total catalyst content being from 0.001 to 15, in particular from 0.05 to 6, % by weight, based on the weight of the compounds (b) used altogether, which are reactive toward isocyanates. Possible catalysts (c) are mentioned below by way of example: tertiary amines, for example triethylamine, tributylamine, dimethylbenzylamine, dicyclohexylmethylamine, dimethylcyclo-hexylamine, N,N,N′,N′-tetramethyldiaminodiethyl ether, bis-(dimethylaminopropyl)urea, N-methyl- and N-ethylmorpholine, N-cyclohexylmorpholine, N,N,N′,N′-tetramethylethylenediamine, N,N,N′,N′-tetrarnethylbutanediamine, N,N,N′,N′-tetramethylhexane-1,6-diamine, pentamethyldiethylenetriamine, dimethylpiperazine, N-dimethylaminoethylpiperidine, 1,8-diazabicyclo[5.4.0]undec-7-ene, 1,2-dimethylimidazole, 1-azabicyclo[2.2.0]octane and 1,4-diazabicyclo[2.2.2]octane (DABCO), alkanolamine compounds, such as triethanolamine, triisopropanol-amine, N-methyl- and N-ethyldiethanolamine, dimethylaminoethanol and 2-(N,N-dimethylaminoethoxy)ethanol, N,N′,N″-tris(dialkylaminoalkyl)hexahydro-triazines, e.g. N,N′,N″-tris(dimethylaminopropyl)-s-hexahydrotriazine, preferably triethylenediamine, pentamethylenediethylenetriamine and/or bis(dimethylamino) ether; metal salts, for example inorganic and/or organic compounds of iron, of lead, of zinc and/or of tin in customary oxidation states of the metal, for example iron(II) chloride, zinc chloride, lead octanoate and preferably tin compounds, such as tin(II) compounds, in particular tin dioctanoate and tin diethylhexanoate, and/or tin(IV) compounds, such as dialkyltin di(isooctylmercaptoacetate), dialkyltin di(2-ethylhexylmaleate), dialkyltin di(2-ethylhexylmercaptoacetate), dialkyltin di(isooctylmercaptoacetate), dialkyltin dilaurate, dialkyltin dimaleate and dialkyltin di(mercaptoacetate); furthermore, amidines, such as 2,3-dimethyl-3,4,5,6-tetrahydropyrimidine, tetraalkylammonium hydroxides, such as tetramethylammonium hydroxide, alkali metal hydroxides, such as sodium hydroxide, and alkali metal alcoholates, such as sodium methylate and potassium isopropylate, and alkali metal salts of long-chain fatty acids having from 10 to 20 carbon atoms and, if required, OH side groups may be used as catalysts. The catalysts mentioned by way of example can be used individually or as mixtures containing at least two of said catalysts.

If required, conventional substances may be used as assistants and/or additives in the novel process. Examples are surface-active substances, internal mold release (IMR) agents, fillers, dyes, pigments, flameproofing agents, hydrolysis stabilizers, fungistatic and bacteriostatic substances and UV stabilizers and antioxidants. The use of pigments and/or dyes for obtaining tinted/colored moldings is also possible.

The concomitant use of a solvent or diluent for the reaction according to step (3) is generally not necessary. In a preferred embodiment, however, a solvent or a mixture of two or more solvents is used. Suitable solvents are, for example, hydrocarbons, in particular toluene, xylene or cyclohexane, esters, in particular ethylglycol acetate, ethyl acetate or butyl acetate, amides, in particular dimethylformamide or N-methylpyrrolidone, sulfoxides, in particular dimethyl sulfoxide, ethers, in particular diisopropyl ether or methyl tert-butyl ether, or preferably cyclic ethers, in particular tetrahydrofuran or dioxane.

The present invention also relates to a polyurethane obtainable by an integrated process comprising at least the following steps:

(1) epoxidation of propene with at least one hydroperoxide to give propylene oxide;

(2) reaction of the propylene oxide from step (1) or a mixture of the propylene oxide from step (1) and at least one further alkylene oxide to give a polyether alcohol using at least one multimetal cyanide compound as a catalyst;

(3) reaction of a polyether alcohol from step (2) with at least one isocyanate.

Novel polyurethanes are distinguished in particular by a low content of impurities, for example C6 compounds. The novel polyurethanes are thus particularly suitable for the preparation of polyurethane foam, polyurethane cast skins and elastomers. Among polyurethane foams, foams which are used in the automotive and furniture industries, such as semirigid foams, rigid integral foams and flexible integral foams or RIM materials (RIM=reaction injection molding), are particularly preferred:

The present invention therefore also relates to a polyurethane foam obtainable by an integrated process comprising at least the following steps:

(1) epoxidation of propene with at least one hydroperoxide to give propylene oxide;

(2) reaction of the propylene oxide from step (1) or of a mixture of the propylene oxide from step (1) and at least one further alkylene oxide to give a polyether alcohol, in particular by using multimetal cyanide compounds as catalyst;

(3) reaction of a polyether alcohol from step (2) with at least one isocyanate;

(4) foaming of the polyurethane obtained by the reaction according to step (3).

Processes for the preparation of polyurethane foams are described, for example, in Becker, Braun, Polyurethane, Kunststoffhandbuch, Vol. 7, Carl-Hanser-Verlag, Munich, 3rd Edition, 1993, pages 193 to 265.

In a preferred embodiment, the present invention relates to a polyurethane, the polyether alcohol used for the preparation of the polyurethane and obtainable according to step (2) having at least one mixed block of ethylene oxide/propylene oxide units.

The present invention also relates to a polyurethane, the polyether alcohol used for the preparation of the polyurethane and obtainable according to step (2) having at least one terminal propylene oxide block.

Such polyurethanes are, for example, suitable for the production of moldings, in particular moldings of flexible polyurethane slabstock foam. The low content of impurities is advantageous here since troublesome odors which may emanate from the flexible foam molding therefore do not occur.

The narrower molecular weight distributions owing to the low content of monofunctional secondary compounds furthermore leads to an improved processing range during foaming.

In a further embodiment, the present invention therefore also relates to moldings comprising a polyurethane or a polyurethane foam which can be prepared by means of a novel integrated process, as well as the use of a polyurethane or a polyurethane foam prepared according to the present invention for the preparation of moldings.

Novel moldings are, for example, mattresses, cushions, moldings for interior automotive trim or upholstered furniture.

Specific examples of novel moldings are:

flexible foams, in particular mattresses, moldings for interior automotive trim, for example automobile seats, sound-absorbing moldings, for example floor carpets and/or upholstered furniture, sponges, cushions, pillows, seats, upholstery for office chairs, backrests and orthopedic products;

thermoplastic polyurethanes, in particular for use in cables, tubing, animal identity tags, railway pads, films, shoe soles and accessories, bandage rolls, ski tips;

cold cast elastomers, in particular for use in sheathing of lifting and carrying belts, fabric coatings, coating of conveyor belts, impact protection components, industrial edge protectors, toothed belts, sieves for abrasive bulk materials, scrapers and share bars, transport stars and rolls, roll coating, floor protection mats for heavy construction machinery, casing components, coating of deburring drums, pump components and pump casings, outdoor pipe coatings, container linings, vehicle floor mats, pigs, cyclones, heavy-load rollers, deflection pulleys, guide pulleys, guide rolls and fixed rollers, idler pulleys, special coatings on conveyor belts, hydrolysis- and abrasion-resistant chute coatings, coatings on truck loading surfaces, bumpers, clutch components, buoy coatings, inline skate wheels, special rollers, high-performance pump components;

flexible integral foams, in particular steering wheels, air filter gaskets, gearshift knob, cable sheathing, container casing, arm rests, shoe soles of polyurethane;

polyurethane coatings, in particular for floor coverings, finishing of materials, such as wood, leather, metal sheets;

polyurethane cast skins, in particular for use as inlays for moldings, such as dashboards, automobile door claddings, truck and car seats, floor mats;

rigid polyurethane foams, in particular for use as heat insulation material or as construction material;

rigid integral foams, in particular for use as construction and decorative elements for indoor and outdoor use, complex furniture, interior automotive components, skis and snowboards and technical functional components;

RIM foams, in particular for the production of finished articles for exterior use in the automotive sector, such as front and rear skirts and door sill scuff plates, and in the commercial vehicle sector, such as large-area claddings, fenders and wheel housings;

thermoformed foams, in particular for the production of ultralight composite structures, for use as a roof cladding element in vehicle construction;

semirigid foams, in particular for the foam-backing of films, skins or leather and fiber-reinforced bearing components, semirigid foams for the production of sliding roof linings for sunroofs or door side panels.

1. An integrated process for the preparation of a polyurethane, comprising the following steps:
(1) epoxidation of propene with at least one hydroperoxide to give propylene oxide;
(2) reaction of the propylene oxide from step (1) or a mixture of the propylene oxide from step (1) and at least one further alkylene oxide with an initiator to give a polyether alcohol using at least one multimetal cyanide compound as a catalyst; and
(3) reaction of a polyether alcohol from step (2) with at least one isocyanate.

2. An integrated process for the preparation of a polyurethane as claimed in claim 1, wherein the hydroperoxide used in step (1) is hydrogen peroxide.

3. An integrated process for the preparation of a polyurethane as claimed in claim 1, wherein the propylene oxide obtained in step (1) contains <1 ppm of C6 components.

4. An integrated process for the preparation of a polyurethane as claimed in claim 1, wherein the epoxidation according to step (1) is carried out in the presence of a titanium-containing zeolite catalyst.

5. An integrated process for the preparation of a polyurethane as claimed in claim 1, wherein the multimetal cyanide compound contains zinc, cobalt or iron or two thereof.

6. A polyurethane obtainable by an integrated process comprising at the following steps:
(1) epoxidation of propene with at least one hydroperoxide to give propylene oxide;
(2) reaction of the propylene oxide from step (1) or a mixture of the propylene oxide from step (1) and at least one further alkylene oxide with an initiator to give a polyether alcohol using at least one multimetal cyanide compound as a catalyst; and
(3) reaction of a polyether alcohol from step (2) with at least one isocyanate.

7. A polyurethane as claimed in claim 6, wherein the polyether alcohol used for the preparation of the polyurethane and obtained in accordance with step (2) has at least one mixed block of ethylene oxide/propylene oxide units.

8. A polyurethane as claimed in claim 6, wherein the polyether alcohol used for the preparation of the polyurethane and obtained in accordance with step (2) has at least one terminal propylene oxide block.

9. A polyurethane foam obtainable by obtained in accordance with an integrated process comprising at least the following steps:
(1) epoxidation of propene with at least one hydroperoxide to give propylene oxide;
(2) reaction of the propylene oxide from step (1) or a mixture of the propylene oxide from step (1) and at least one further alkylene oxide with an initiator to give a polyether alcohol using at least one multimetal cyanide compound as a catalyst;
(3) reaction of a polyether alcohol from step (2) with at least one isocyanate; and
(4) foaming of the polyurethane obtained by the reaction according to step (3).

10. A molding comprising a polyurethane which is prepared by means of an integrated process as claimed in any of claims 1 to 5.

11. An integrated process for the preparation of a polyurethane as claimed in claim 2, wherein the propylene oxide obtained in step (1) contains <1 ppm of C6 components.

12. An integrated process for the preparation of a polyurethane as claimed in claim 2, wherein the epoxidation according to step (1) is carried out in the presence of a titanium-containing zeolite catalyst.

13. An integrated process for the preparation of a polyurethane as claimed in claim 3, wherein the epoxidation according to step (1) is carried out in the presence of a titanium-containing zeolite catalyst.

14. An integrated process for the preparation of a polyurethane as claimed in claim 2, wherein the multimetal cyanide compound contains zinc, cobalt or iron or two thereof.

15. An integrated process for the preparation of a polyurethane as claimed in claim 3, wherein the multimetal cyanide compound contains zinc, cobalt or iron or two thereof.

16. An integrated process for the preparation of a polyurethane as claimed in claim 4, wherein the multimetal cyanide compound contains zinc, cobalt or iron or two thereof.

17. A polyurethane as claimed in claim 7, wherein the polyether alcohol used for the preparation of the polyurethane and obtained in accordance with step (2) has at least one terminal propylene oxide block.

18. A molding comprising a polyurethane which can be prepared by means of an integrated process for the preparation of a polyurethane, comprising the following steps:
(1) epoxidation of propene with a hydroperoxide to give propylene oxide;
(2) reaction of the propylene oxide from step (1) or a mixture of the propylene oxide from step (1) and at least one further alkylene oxide with an initiator to give a polyether alcohol using a multimetal cyanide compound as a catalyst; and
(3) reaction of a polyether alcohol from step (2) with at least one isocyanate.

19. A polyurethane foam obtained in accordance with an integrated process comprising the following steps:
(1) epoxidation of propene with a hydroperoxide to give propylene oxide;
(2) reaction of the propylene oxide from step (1) or a mixture of the propylene oxide from step (1) and at least one further alkylene oxide with an initiator to give a polyether alcohol using a multimetal cyanide compound as a catalyst;
(3) reaction of the polyether alcohol from step (2) with an isocyanate;
(4) foaming of the polyurethane obtained by the reaction according to step (3).
